(19) United States
(12) Patent Application Publication
(10) Pub. No.: US 2016/0333436 A1
(43) Pub. Date: Nov. 17, 2016

(54) Multilayer Cutting Blade Having a Stainless Steel Core

(71) Applicant: SEB S.A., Ecully (FR)

(72) Inventors: Simon Allemand, Cran Gevrier (FR); Stephane Tuffe, Cognin (FR); William A. Groll, McMurray, PA (US); John C. Watkins, Washington, PA (US)

(21) Appl. No.: 15/106,629

(22) PCT Filed: Dec. 18, 2014
(86) PCT No.: PCT/FR2014/053434

§ 371 Date: Jun. 20, 2016

(30) Foreign Application Priority Data
Dec. 20, 2013 (FR) 1363312

(51) Int. Cl. C21D 9/18; C22F 1/08; C21D 1/58; B23P 15/28; C21D 1/18; B23K 1/00; B23K 35/30; B26B 9/00; C22C 9/06; C21D 1/613

(52) U.S. Cl. CPC C21D 9/18; C22C 9/06; C22F 1/08; C21D 1/58; C21D 1/613; C21D 1/18; B23K 1/0008; B23K 35/302; B26B 9/00; B23P 15/28; C21D 2211/008

(57) ABSTRACT

Provided is a multilayer cutting blade (1) including a core (2) that has a cutting wire (3), two side flanks (5), and two intermediate connecting thicknesses (4), the side flanks (5) being made of a corrosion-resistant tough metal alloy, each intermediate connecting thickness (4) having a first face (8) for connecting to the core (2) and a second face (9) for connecting to one or the other of the side flanks (5), the first connecting face (8) and the second connecting face (9) being made of copper or a copper alloy. The core (2) is made of martensitic stainless steel, and the thickness of the core (2) is greater than or equal to one third of the thickness of the cutting blade (1), and preferably greater than or equal to half the thickness of the cutting blade (1).

This invention pertains to the technical field of cutting blades and their methods of production.

In particular, this invention pertains to the field of cutlery, as well as the field of household appliances or cooking appliances comprising a slicing tool, such as food processors, mincers or blenders, and immersion blenders in particular.

Patent FR2554388 describes making a three-layer steel clad material comprising a hard chromium steel core and slide flanks made of a corrosion-resistant, tough material, such as stainless steel containing nickel or chrome. This clad material is made without an intermediate connecting layer between the hard core and the tough side flanks.

U.S. Pat. No. 5,256,496 describes making a clad material that can be used as a cutting tool, comprising a high carbon steel core covered with side flanks made of titanium or a titanium alloy. Several types of materials or alloys can be used for the intermediate layers used for brazing the core with the side flanks, particularly copper or silver-palladium-copper or copper-silver alloys. One disadvantage of the high carbon steel used for the core is its very poor corrosion resistance. Moreover, the titanium used for the side flanks is very expensive, difficult to polish, has a low modulus of elasticity and also changes color easily when heated.

Patent CN201055998 describes making a cutting tool, comprising a hard steel core covered with stainless steel side flanks, with a copper intermediate layer. The constituents of this cutting tool are less expensive; however, hardened steel offers insufficient corrosion resistance.

One purpose of this invention is to make a cutting blade with good initial cutting performance and satisfactory longevity, that is not very fragile, can be sharpened, and offers good impact and corrosion resistance.

Another purpose of this invention is to provide a method of producing a cutting blade with good initial cutting performance and satisfactory longevity, that is not very fragile, can be sharpened and offers good impact and corrosion resistance.

These purposes are achieved with a multilayer cutting blade, comprising a core with a cutting edge, two side flanks each partially covering one of the surfaces of the core, and two intermediate connecting thicknesses each positioned between the core and either one of the side flanks, the side flanks being made of a corrosion-resistant, tough metal alloy, each intermediate connecting thickness having a first connecting surface that connects to the core and a second connecting surface that connects to either one of the side flanks, the first connecting surface and the second connecting surface being made of copper or a copper alloy, given that the core is made of martensitic stainless steel and the thickness of the core is greater than or equal to one-third the thickness of the cutting blade. Preferably, the thickness of the core is greater than or equal to half the thickness of the cutting blade, and that the cutting edge has a point angle of between 25° and 35°.

The core is made of a grade of martensitic stainless steel that makes it possible to attain a strong hardness after quenching. The use of a grade of martensitic stainless steel for the core makes it possible to combine satisfactory cutting performance with satisfactory corrosion resistance of the cutting edge. A grade of martensitic stainless steel making it possible to attain a strong hardness after quenching is preferred. The thickness of the core ensures sufficient stiffness for attaining satisfactory flexion strength, significantly limiting permanent deformations of the cutting blade. The intermediate connecting thicknesses make it possible to have adhesion between the martensitic stainless steel core and the side flanks, while showing the multilayer structure of the cutting blade. Furthermore, the side surfaces made of a tough material with good corrosion resistance protect against impact damage. The point angle of between 25° and 35° optimizes the cutting performance.

Advantageously, the core has a hardness of greater than or equal to 52 HRC, and preferably greater than or equal to 58 HRC. This characteristic makes it possible to attain conditions that promote optimal cutting performance.

Also advantageously, the core has a hardness of less than or equal to 62 HRC, and preferably less than or equal to 60 HRC. This characteristic makes it possible to prevent the cutting edge of the cutting blade from being too fragile.

Also advantageously, the cutting edge has a point angle of between 20° and 50°. This characteristic makes it possible to attain good cutting performance. Preferably, the point angle is between 25° and 35°. This characteristic optimizes the cutting performance.

In one advantageous method of implementation, the cutting edge is defined by a dual-surface bevel.

Thus, advantageously, the dual-surface bevel is symmetrical.

In one method of implementation, at least one of the intermediate connecting thicknesses is formed by a layer of copper or a copper alloy.

In another method of implementation, at least one of the intermediate connecting thicknesses is formed by a multilayer structure comprising two exterior layers made of copper or a copper alloy, forming the first connecting surface and the second connecting surface, at least one interleaf layer made of a corrosion-resistant, tough metal alloy being arranged between the two exterior layers, and an interface layer made of copper or a copper alloy being arranged between two adjacent interleaf layers. Thus, advantageously, the one or more interleaf layer(s) are made of stainless steel.

In one method of implementation, the first connecting surface and the second connecting surface of each intermediate connecting thickness are composed of pure copper or a copper-nickel alloy comprising up to 25% nickel, and preferably a copper-nickel alloy comprising up to 10% nickel. These arrangements are suitable in particular for a cutting blade produced by cladding.

In another method of implementation, the first connecting surface and the second connecting surface of each intermediate connecting thickness are composed of a copper-silver alloy for high-temperature brazing.

Also advantageously, the side flanks are made of stainless steel. This arrangement makes it possible to produce a high-performance cutting blade without using very expensive materials.

Thus, advantageously, the side flanks are made of austenitic stainless steel. Such a stainless steel ensures excellent corrosion resistance of the side flanks of the cutting blade.

In one advantageous method of implementation, the side flanks have a non-beveled external surface that is coated, particularly with a PVD-type coating or with an electrolytic coating. This arrangement allows the blade to glide through food while cutting.

Also advantageously, the cutting blade has a total thickness of between 1 and 8 mm.

Also advantageously, the core has a thickness of between 0.2 and 4 mm.

Also advantageously, each intermediate connecting thickness has a thickness of between 50 and 250 μm.

Also advantageously, each side flank has a thickness of between 0.2 and 2 mm.

The invention also pertains to a method of producing a multilayer cutting blade including the following steps:

Creation or supply of a multilayer sheet comprising:
a core made of martensitic stainless steel, the thickness of which is greater than or equal to one-third the thickness of the multilayer structure,
two side flanks made of a corrosion-resistant, tough metal alloy,
two intermediate connecting thicknesses each arranged between the core and either one of the side flanks, each intermediate connecting thickness being made of copper or a copper alloy, or having alternating layers made of either copper or a copper alloy, or a corrosion-resistant, tough metal alloy, such that each layer of the intermediate connecting thicknesses adjacent to the core or to one of the side flanks is made of copper or a copper alloy,

Cutting out a cutting blade form from the multilayer sheet,

Heat treatment of the cutting blade form at a temperature of between 1000° C. and 1100° C., followed by oil or air quenching,

Tempering treatment of the cutting blade form at a temperature of between 200° and 400° C.,

Beveling of at least one part of one edge of the cutting blade form, to form a cutting edge in the core, the cutting edge having a point angle of between 25° and 35°.

In one method of implementation, the process consists of making or using a multilayer sheet assembled by cladding, in which the layers of the intermediate connecting thicknesses made of copper or a copper alloy are composed of pure copper or a copper-nickel alloy comprising up to 25% nickel, and preferably a copper-nickel alloy comprising up to 10% nickel.

In one method of implementation, the process consists of making or using a multilayer sheet assembled by brazing, in which the layers of the intermediate connecting thicknesses made of a copper alloy are composed of a copper-silver alloy for high-temperature brazing.

The invention will be more clearly understood upon review of two non-limiting examples of implementation, illustrated in the attached figures, in which:

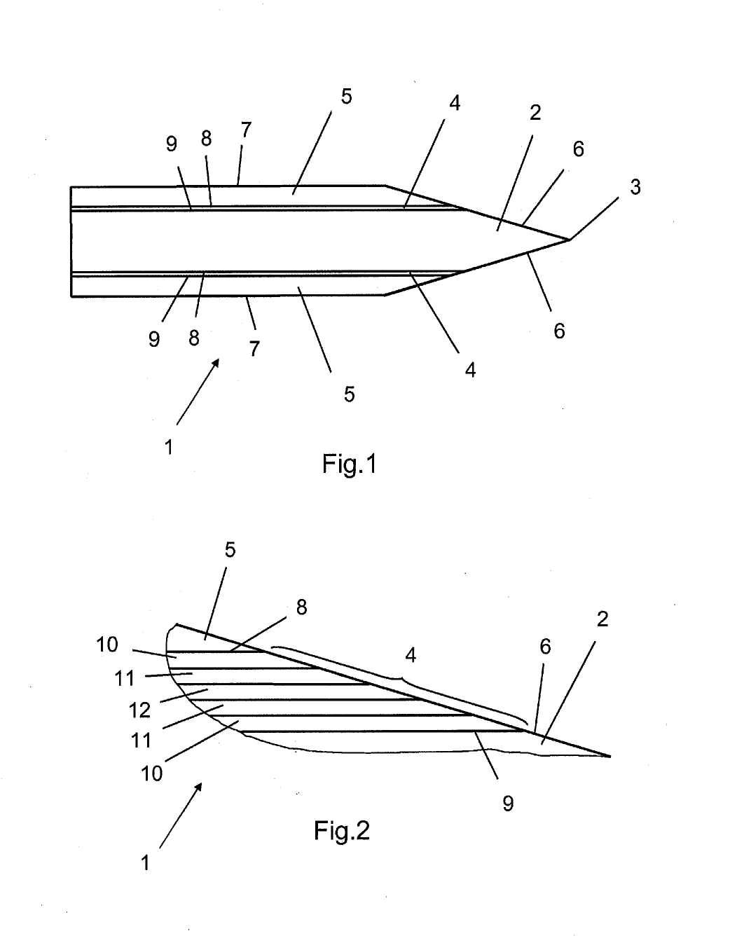

FIG. 1 is a schematic cross-section view of a first example of implementation of a cutting blade described in the invention,

FIG. 2 is a partial schematic cross-section view of a second example of implementation of a cutting blade described in the invention.

The cutting blade (1) is a multilayer cutting blade, comprising a core (2) with a cutting edge (3), two side flanks (5) each partially covering one of the surfaces of the core, two intermediate connecting thicknesses (4) each being arranged between the core (2) and either one of the side flanks (5).

Each intermediate connecting thickness (4) has a first connecting surface (8) that connects to the core (2) and a second connecting surface (9) that connects to either one of the side flanks (5).

In the example of implementation depicted in FIG. 1, the cutting edge (3) is defined by a dual-surface bevel (6) that is preferably symmetrical. The bevel (6) extends to the side flanks (5), showing the intermediate connecting thicknesses (4) between the core (2) and the side flanks (5) on either side of the cutting edge (3). Each of the side flanks (5) has a non-beveled external surface (7) extending to the beveled area (6). As a variation, the beveling (6) may be done on only one surface of the cutting blade (1) after having formed the cutting edge (3).

The cutting edge (3) advantageously has a point angle of between 20° and 50°, and preferably between 25° and 35°. In the example of implementation depicted in FIG. 1, the point angle of the cutting edge (3) is 30°.

In the example of implementation depicted in FIG. 1, each intermediate connecting thickness (4) is formed by a layer of copper or a copper alloy.

In the example of implementation depicted in FIG. 2, each intermediate connecting thickness (4) is formed by a multilayer structure comprising two exterior layers (10) made of copper or a copper alloy, two interleaf layers (11) made of a corrosion-resistant, tough metal alloy arranged between the exterior layers (10), and an interface layer (12) made of copper or a copper alloy arranged between the two interleaf layers (11). The exterior layers (10) form the first connecting surface (8) and the second connecting surface (9).

Thus, the intermediate connecting thicknesses (4) are formed by a layer of copper or a copper alloy constituting the first connecting surface (8) and the second connecting surface (9), or by alternating layers of copper or a copper alloy, on the one hand, and interleaf layers (11) made of a corrosion-resistant, tough metal alloy, on the other hand, the first connecting surface (8) and the second connecting surface (9) being made of copper or a copper alloy.

The core (2) is made of martensitic stainless steel. It is thus possible to attain a strong hardness after quenching, particularly a hardness of greater than or equal to 52 HRC, and preferably greater than or equal to 58 HRC. A hardness of less than or equal to 62 HRC, and preferably less than or equal to 60 HRC, is nevertheless preferred, to prevent the cutting edge (3) from being too fragile. The grades of martensitic stainless steel typically used are, for example: X65Cr13, X105CrMoV15, X50CrMoV15 and X40CrMoVN16-2.

In one method of implementation, the first connecting surface (8) and the second connecting surface (9) of each intermediate connecting thickness (4) are composed of pure copper, or a 90% Cu-10% Ni copper-nickel alloy with a brass-type coloration. Such coloration is observed for a copper-nickel alloy comprising up to 10% nickel. For higher nickel content levels, the alloy loses its coloration and therefore its aesthetic appeal. Nevertheless, copper-nickel alloys comprising up to 25% nickel can be used. These alloys used in the intermediate connecting thicknesses (4) contribute very good mechanical strength to the clad assembly without delamination up to approximately 1100° C., which makes it possible to perform the quenching necessary for the hardening of the martensitic stainless steel core (2). Such a method of implementation corresponds in particular to making the multilayer cutting blade (1) by means of cladding.

In another method of implementation, the multilayer cutting blade (1) can be made by brazing. A silver copper alloy for high-temperature brazing can be used to form the first connecting surface (8) and the second connecting surface (9) of each intermediate connecting thickness (4).

The side flanks (5) are made of a corrosion-resistant, tough metal alloy. The side flanks (5) are advantageously made of stainless steel, particularly austenitic stainless steel. Preferably, an austenitic stainless steel of the type X5CrNi18-10 (SUS304) is used, in order to ensure excellent corrosion resistance of the non-beveled external surfaces (7) of the cutting blades (1). Nevertheless, other materials may be used, particularly titanium or its alloys, or a ferritic or martensitic stainless steel. A multilayer structure may also be considered for the side flanks (5), particularly a stack of several different layers of different kinds of stainless steel.

If desired, the side flanks (5) may have a non-beveled external surface (7) that is coated, particularly with a PVD-type (physical vapor deposition) coating, or with an electrolytic coating.

The ratio between the thickness of the core (2) and the total thickness of the multilayer cutting blade (1) is greater than or equal to ⅓, and preferably greater than or equal to 0.5. Thus, the thickness of the core (2) is greater than or equal to one-third the thickness of the cutting blade (1), and preferably greater than or equal to half the thickness of the cutting blade (1). Indeed, for lesser thicknesses of the core (2), the flexion strength of the multilayer material forming the cutting blade (1) would be too low, with a risk of permanent deformation after flexion. For better rigidity of the cutting blade (1), the thickness of the core (2) is preferably greater than or equal to half the total thickness of the multilayer cutting blade (1). The ratio between the thickness of the core (2) and the total thickness of the multilayer cutting blade (1) is preferably less than 0.8, in order to have sufficient thicknesses for the side flanks (5) and for the intermediate connecting thicknesses (4).

The cutting blade (1) preferably has a total thickness of between 1 mm and 8 mm. The thickness of the cutting blade (1) is defined between the external surfaces of the side flanks (5). The core (2) may have a thickness of between 0.2 and 4 mm. Each intermediate connecting thickness (4) can have a thickness of between 50 and 250 μm. Each side flank (5) can have a thickness of between 0.2 mm and 2 mm.

There are several different ways of producing the multilayer cutting blade (1), particularly through cladding or brazing.

Cladding is done at a high temperature, typically between 800° C. and 1100° C. This technological method of cladding method makes it possible to attain excellent adhesion of the different layers of the multilayer cutting blade (1), particularly during heat treatment. The main difficulty is not to modify the metallurgical properties of the martensitic stainless steel forming the core (2): increase in the size of the grains, change in the distribution of secondary carbides, etc. If desired, the cladding can be done in a vacuum.

Brazing can be done using a high-temperature braze in a silver/copper alloy for the intermediate connecting thicknesses (4).

The cutting blade (1) is cut out after producing the multilayer structure comprising the side flanks (5), the intermediate connecting thicknesses (4) and the core (2), generally by laser cutting.

In the case of 440C stainless steel, for example, a heat treatment between 1010° and 1066° C., followed by an oil or air quenching, is done, followed by a tempering between 150° and 250° C. for 1 hour. A Rockwell C hardness of greater than 55 HRC is thus attained. This heat treatment confers satisfactory cutting strength and power, combined with good impact and corrosion resistance. A grinding consisting of machining at least one of the two sides of the cutting blade (1) is performed to create the bevel (6) in order to create the sharp ridge forming the cutting edge (3).

A measurement of the cutting performance is done based on characterizations that quantify the cutting strength of a cutting blade. Such a test is described in standard EN ISO 8442-5. This standard describes how to measure the ICP (initial cutting performance) and TCC (total card cut) of a cutting blade. The treatments described above significantly improve the TCC parameter without detracting from the initial cutting performance. In the same way, the corrosion resistance of the blades is verified according to the descriptions in standard EN ISO 8442-1. Corrosion resistance tests were used to verify that the corrosion resistance of the 304 stainless steel was not affected.

As a variation, at least one of the intermediate connecting thicknesses (4) can be formed by a layer of copper or a copper alloy.

As a variation, at least one of the intermediate connecting thicknesses (4) can be formed by a multilayer structure comprising two exterior layers (10) made of copper or a copper alloy, at least one interleaf layer (11) made of a corrosion-resistant, tough metal alloy arranged between the two exterior layers (10), an interface layer (12) made of copper or a copper alloy thus being arranged between two adjacent interleaf layers (11) when the intermediate connecting thickness (4) has several interleaf layers (11). Thus, each interleaf layer (11) is arranged between two exterior layers (10), or between one exterior layer (10) and one interface layer (12) or between two interface layers (12).

The invention also pertains to a method of producing a multilayer cutting blade (1) comprising the following steps:

Creation or supply of a multilayer sheet comprising:
a core (2) made of martensitic stainless steel, the thickness of which is greater than or equal to one-third the thickness of the multilayer structure,
two side flanks (5) made of a corrosion-resistant, tough metal alloy,
two intermediate connecting thicknesses (4) each arranged in between the core (2) and either one of the side flanks (5), each intermediate connecting thickness (4) being made of copper or a copper alloy, or having alternating layers made of either copper or a copper alloy, or a corrosion-resistant, tough metal alloy, such that each layer of the intermediate connecting thicknesses (4) adjacent to the core or to one of the side flanks is made of copper or a copper alloy,

Cutting out a cutting blade (1) form from the multilayer sheet,

Heat treatment of the cutting blade (1) form at a temperature of between 1000° C. and 1100° C., followed by oil or air quenching,

Tempering treatment of the cutting blade (1) form at a temperature of between 200° and 400° C.,

Beveling of at least one part of one edge of the cutting blade (1) form, to form a cutting edge (3) in the core (2).

In one method of implementation, the process consists of making or using a multilayer sheet assembled by cladding, in which the layers of the intermediate connecting thicknesses (4) made of copper or a copper alloy are composed of pure copper or a copper-nickel alloy comprising up to 25% nickel, and preferably a copper-nickel alloy comprising up to 10% nickel.

In one method of implementation, the process consists of making or using a multilayer sheet assembled by brazing, in which the layers of the intermediate connecting thicknesses (4) made of a copper alloy are composed of a copper-silver alloy for high-temperature brazing.

This invention is in no way limited to the examples of implementation described and their variations, but encompasses many modifications within the scope of the claims.

1. Multilayer cutting blade, comprising a core with a cutting edge, two side flanks each partially covering one of the surfaces of the core, and two intermediate connecting thicknesses each arranged between the core and either one of the side flanks, the side flanks being made of a corrosion-resistant, tough metal alloy, each intermediate connecting thickness having a first connecting surface that connects it to the core and a second connecting surface that connects it to either one of the side flanks, the first connecting surface and the second connecting surface being made of copper or a copper alloy, wherein the core is made of martensitic stainless steel, in that a thickness of the core is greater than or equal to half a thickness of the cutting blade, and in that the cutting edge has a point angle of between 25° and 35°.

2. Multilayer cutting blade described in claim 1, wherein the core has a hardness of greater than or equal to 52 HRC, and preferably greater than or equal to 58 HRC.

3. Multilayer cutting blade described in claim 1, wherein the core has a hardness of less than or equal to 62 HRC.

4. Multilayer cutting blade described in claim 1, wherein the cutting edge is defined by a dual-surface bevel.

5. Multilayer cutting edge described in claim 4, wherein the dual-surface bevel is symmetrical.

6. Multilayer cutting edge described in claim 1, wherein at least one of the intermediate connecting thicknesses is formed by a layer of copper or a copper alloy.

7. Multilayer cutting blade described in claim 1, wherein at least one of the intermediate cutting thicknesses is formed by a multilayer structure comprising two exterior layers made of copper or a copper alloy, forming the first connecting surface and the second connecting surface, at least one interleaf layer made of a corrosion-resistant, tough metal alloy being arranged between the two exterior layers, and an interface layer made of copper or a copper alloy being arranged between two adjacent interleaf layers.

8. Multilayer cutting blade described in claim 1, wherein the first connecting surface and the second connecting surface of each intermediate connecting thickness are composed of pure copper or a copper-nickel alloy comprising up to 25% nickel.

9. Multilayer cutting blade described in claim 1, wherein the first connecting surface and the second connecting surface of each intermediate connecting thickness are composed of a copper-silver alloy for high-temperature brazing.

10. Multilayer cutting blade described in claim 1, wherein the side flanks are made of stainless steel.

11. Multilayer cutting blade described in claim 1, wherein the side flanks are made of austenitic stainless steel.

12. Multilayer cutting blade described in claim 1, wherein the side flanks have a non-beveled external surface that is coated, by one of a PVD-type coating, or an electrolytic coating.

13. Multilayer cutting blade described in claim 1, wherein it has a total thickness of between 1 and 8 mm.

14. Multilayer cutting blade described in claim 1, wherein the core has a thickness of between 0.2 and 4 mm.

15. Multilayer cutting blade described in claim 1, wherein each intermediate connecting thickness has a thickness of between 50 and 250 μm.

16. Multilayer cutting blade described in claim 1, wherein each side flank has a thickness of between 0.2 mm and 2 mm.

17. Multilayer cutting blade described in claim 1, wherein the thickness of the core is less than 0.8 times the thickness of the cutting blade.

18. Method of producing a multilayer cutting blade comprising the following steps:
Providing a multilayer sheet comprising:
a core made of martensitic stainless steel, the thickness of which is greater than or equal to half the thickness of the multilayer structure,
two side flanks made of a corrosion-resistant, tough metal alloy,
two intermediate connecting thicknesses each arranged between the core and either one of the side flanks, each intermediate connecting thickness being made of copper or a copper alloy, or having alternating layers made of either copper or a copper alloy, or a corrosion-resistant, tough metal alloy, such that each layer of the intermediate connecting thicknesses adjacent to the core or to one of the side flanks is made of copper or a copper alloy,
Cutting out a cutting blade form from the multilayer sheet,
Heat treatment of the cutting blade form at a temperature of between 1000° C. and 1100° C., followed by oil or air quenching,
Tempering treatment of the cutting blade form at a temperature of between 200° and 400° C.,
Beveling of at least one part of one edge of the cutting blade form, to form a cutting edge in the core, the cutting edge having a point angle of between 25° and 35°.

19. Method of producing a multilayer cutting blade described in claim 18, characterized in that it consists of making or using a multilayer sheet assembled by cladding, in which the layers of the intermediate connecting thicknesses made of copper or a copper alloy are composed of pure copper or a copper-nickel alloy comprising up to 25% nickel, and preferably a copper-nickel alloy comprising up to 10% nickel.

20. Method of producing a multilayer cutting blade described in claim 18, characterized in that it consists of making or using a multilayer sheet assembled by brazing, in which the layers of the intermediate connecting thicknesses made of a copper alloy are composed of a copper-silver alloy for high-temperature brazing.

21. Method of producing a multilayer cutting blade described in claim 18, wherein the thickness of the core is less than 0.8 times the thickness of the multilayer structure.
